(19) United States
(12) Patent Application Publication
(10) Pub. No.: US 2012/0294741 A1
(43) Pub. Date: Nov. 22, 2012

(54) PUMP TAPPET

(76) Inventors: Masashi Nishimura, Iwata-shi (JP); Shinji Oishi, Iwata-shi (JP); Akio Kato, Iwata-shi (JP)

(21) Appl. No.: 13/574,901

(22) PCT Filed: Dec. 14, 2010
(86) PCT No.: PCT/JP2010/072466

§ 371 Date: Jul. 24, 2012

(30) Foreign Application Priority Data
Jan. 27, 2010 (JP) 2010-015792

(51) Int. Cl. F16H 25/14; F04B 7/00

(52) U.S. Cl. 417/437; 74/55

(57) ABSTRACT

An object of the invention is to provide a pump tappet capable of bearing a large load from a pump plunger even if a case, which is a constituent member of the pump tappet, has a reduced thickness in its intermediate bottom. The invention thus contributes to reduced weight of the overall pump tappet. The case for the pump tappet is formed from an intermediary workpiece 40, which is made by means of a cold forging process of pressing a central region of a round steel material from both surfaces thereby pushing a portion of the material in the central region radially outward, forcing the material to flow axially in an up-down direction, so that an intermediate bottom 40e has a continuous fiber flow.

### TECHNICAL FIELD

The present invention relates to pump tappets.

### BACKGROUND ART

Automotive, direct-fuel injection engines make use of high pressure fuel pumps in order to inject highly pressurized fuel into cylinders. The high pressure fuel pump converts rotating movement of a cam-driven cam shaft into linear reciprocating movement of a pump plunger. The pump plunger's linear reciprocating movement is utilized to send fuel into a high-pressure chamber, where the fuel is pressurized to a predetermined high level before the fuel is injected into combustion chambers. The high pressure fuel pump includes pump tappets as its constituent members for the conversion of the cam shaft rotating movement into a linear reciprocating movement to be transmitted to the pump plungers.

The pump tappets may be classified into different types such as roller tappet which includes a roller bearing, and mushroom-shaped tappet which has a shape resembling a mushroom, depending on their shape of contacting portion with the cam for example.

DE 10 2005 047 234, A1(Patent Literature 1) discloses a technique related to a high-pressure pump which includes a roller tappet. FIG. 20 is a sectional view, showing part of this high-pressure pump which includes a roller tappet, according to Patent Literature 1.

This high-pressure pump which is disclosed in Patent Literature 1 includes a cam shaft 1 which makes a rotating movement in Arrow A direction in FIG. 20; a cam 2 which is provided around an outer diameter surface of the cam shaft 1; a tappet 4 which makes contact with the cam 2, converts the rotating movement of the cam shaft 1 into a linear reciprocating movement of itself, transmits the converted movement to a pump plunger 3 (hereinafter, simply called “plunger”) and makes a linear reciprocating movement; the above-mentioned plunger 3 which is a rod-like member that is in contact with the tappet 4 to make a linear reciprocating movement; a high-pressure chamber (not illustrated) in which fuel is sent and pressurized to a high level in the course of the linear reciprocating movement of the plunger 3; a spring 5 which makes contact with the tappet 4 and is disposed around the plunger 3; and a housing 6 which houses the tappet 4, the plunger 3 and the spring 5.

The tappet 4, the plunger 3 and the spring 5 are housed inside an open hole 7 formed in the housing 6. The tappet 4 is guided by an inner diameter surface of the open hole 7 in an up-down direction as in FIG. 20, i.e., in a direction indicated by Arrow XX or in the opposite direction in FIG. 20.

The cam shaft 1 and the tappet 4 are disposed so that an outer diameter surface of the cam 2 are in contact with an outer diameter surface of an outer ring 8a of the roller bearing 8 which is housed in the tappet 4. The plunger 3 has a first end 3a which is in contact with an intermediate bottom formed in a case 9 that is a constituent member of the tappet 4. The spring 5 has an end which is in contact with a spring seat 10 that is provided on the lower surface of the intermediate bottom.

The spring 5 stores its elastic force in the upward direction, i.e., in the direction opposite to the direction indicated by Arrow XX in FIG. 20. The tappet 4 is urged by the elastic force of the spring 5 via the plunger, in the downward direction, i.e., in the direction indicated by Arrow XX in FIG. 20.

Due to the rotating movement of the cam shaft 1, the urge from the spring 5, the guide by the inner diameter surface of the open hole 7, etc., the tappet 4 and the plunger 3 make a linear reciprocating movement in the up-down direction, i.e., in the direction indicated by Arrow XX or the opposite direction thereto, in FIG. 20. The term linear reciprocating movement used herein is a movement in the Arrow XX direction or in the opposite direction thereto as in FIG. 20. The tappet 4 makes a linear reciprocating movement in the Arrow XX direction and in the opposite direction in FIG. 20. When the cam shaft 1 rotates at a high speed, the tappet 4 and the plunger 3 also move at a high speed in their linear reciprocating movement.

The high-pressure chamber is at another, unillustrated end of the plunger 3. Due to the linear reciprocating movement of the plunger 3, the fuel which is supplied into the high-pressure chamber is highly pressurized.

It is anticipated that the fuel pump will handle higher pressures in the future. This means that the load which acts on the intermediate bottom of the tappet 4 that makes contact with the pump's plunger 3 will be increased. The increased load can destroy the intermediate bottom.

The problem may be solved, as disclosed in JP-A H01-110877 Gazette (Patent Literature 2) or in JP-A 2001-500221 Gazette (Patent Literature 3), by increasing the thickness of a pump plunger contacting region in the intermediate bottom.

### CITATION LIST

### Patent Literature

Patent Literature 1: DE 10 2005 047 234 A1 Gazette

Patent Literature 2: JP-A H01-110877 Gazette

Patent Literature 3: JP-A 2001-500221 Gazette

### SUMMARY OF INVENTION

### Technical Problem

However, increasing the thickness of the intermediate bottom of the tappet 4 with which the pump plunger 3 makes contact increases the weight of the tappet by as much. The increased weight increases inertia of the tappet 4 when it makes the reciprocating movement, posing a risk of jumping for example, which will prevent efficient operation of the pump.

Also, as shown in FIG. 19, the case 9, which is a constituent member of the tappet 4, is conventionally made by hollowing out a solid round steel bar by means of cutting operations thereby forming an intermediate bottom 9b on a cylindrical circumferential wall 9a and partitioning the space extending in the up-down direction.

As indicated by fine lines in the diagrammatic representation in FIG. 19, the solid round steel bar from which the case 9 is made has a metallographical structure which looks like a bundle or a flow of a multiple number of fibers, and this flow of fibers is called fiber flow.

As described above, when the case 9 is made by hollowing out a solid round steel bar from both ends by means of cutting operations, the intermediate bottom 9b is formed as a bundle of parallel, short fiber flow in the thickness direction as indicated by fine lines in FIG. 19. This causes a problem that the intermediate bottom 9b is susceptible to fracture along the fiber flow when a large load is applied from the plunger 3 in the direction of the fiber flow.

Therefore, if the case 9 is formed by cutting, load bearing capability of the intermediate bottom 9b must be increased, and in order to achieve this conventionally, the intermediate bottom 9b must be given an increased thickness. This creates a problem of increased weight of the case 9.

It is therefore an object of the present invention to provide a pump tappet which includes a case as a constituent member that has a reduced thickness in its intermediate bottom and bears a large load from the plunger. The invention thus aims at reducing the overall weight of the tappet.

### Solution to Problem

In order to achieve the object, the present invention provides a pump tappet for converting a rotating movement of a cam-driven cam shaft into a linear reciprocating movement of a pump plunger and transmitting the converted movement to the pump plunger while making a linear reciprocating movement together with the pump plunger. The tappet comprises a shaft; an outer ring disposed rotatably around an outer diameter surface of the shaft; and a case which houses the shaft and the outer ring. The case includes a cylindrical circumferential wall and an intermediate bottom provided at an intermediate position of the inner diameter surface of the circumferential wall to partition a space extending in an up-down direction. The case is formed by a cold forging process of pressing a central region of a round steel material from two surfaces thereby pushing a portion of the material at the central region radially outward, forcing the material to flow axially in the up-down direction, thereby leaving a continuous fiber flow in the intermediate bottom region.

The outer ring may be provided via a rolling element such as rollers disposed around the shaft, or may be provided directly around the shaft without any rolling elements.

According to the pump tappet offered by the present invention, the case has an uncut, continuous fiber flow in its intermediate bottom as described above, and therefore has a high load bearing capability even if its thickness is reduced. Hence, this invention enables reducing the overall weight of the case. The reduced weight reduces inertia of the tappet when it makes the reciprocating movement, reducing a risk of jumping and thereby allowing the pump to work efficiently.

The cold forging process may be performed so that the continuous fiber flow in the intermediate bottom will become 90 degrees with respect to the direction of load from the plunger. This improves the load bearing capability to the load from the pump plunger.

Since the intermediate bottom of the case is formed by pressing a central region of the solid round steel material from both surfaces, the fiber flow density in the intermediate bottom is increased over the other regions of the case, resulting in further improved load bearing capability of the intermediate bottom.

The case also has a higher fiber flow density at its corner, or joint, portion between the intermediate bottom and the cylindrical circumferential wall than other portions. This further improves the load bearing capability of the intermediate bottom.

Further, the cylindrical circumferential wall of the case has an edge portion formed into an inward down slope. This further reduces the weight of the case as a constituent part, without changing the height of the case's outer diameter in Direction I as in FIG. 1, or without reducing the surface area of contact between an outer diameter surface of the case and an inner diameter surface 16a of an open hole 16.

Also, an ironing process may be performed to an inner diameter surface of the cylindrical circumferential wall of the case where there is contact by width-defining surfaces of the outer ring. This improves surface coarseness of the contact surface between the outer ring's width-defining surfaces with the case, and therefore reduces heat and wear resulting from the contact by the outer ring's width-defining surfaces.

Also, it is preferable that machining is made in such a way that the case's center of gravity is off a shaft fixing region but elsewhere in the case's cylindrical region. This prevents the case 23 from tilting toward the shaft fixing portion during a centerless grinding operation of an outer surface of the case 23. Since arrangement stabilizes the attitude of the case 23, it becomes possible to perform centerless grinding operation to the outer surface of the case.

Also, it is preferable that the intermediate bottom of the case has a convex surface for contact with the pump plunger. By giving a convex surface to the region which makes contact with the plunger, it becomes possible to reduce wear of the intermediate bottom.

### Advantageous Effects of Invention

According to the pump tappet offered by the present invention, a case has a continuous fiber flow in its intermediate bottom, and therefore has a higher load bearing capability than a case that has the short fiber flow in the intermediate bottom by means of cutting operations even if the thickness of the intermediate bottom is reduced. The invention helps reducing the overall weight of the case. The reduced weight reduces inertia of the tappet when it makes the reciprocating movement, reducing a risk of jumping and thereby allowing the pump to work efficiently.

### BRIEF DESCRIPTION OF THE DRAWINGS

FIG. 1 is a sectional view, showing part of a high-pressure pump which includes a tappet according to an embodiment of the present invention.

FIG. 2 is a front view, showing a longitudinal section of the tappet included in the high-pressure pump in FIG. 1.

FIG. 3 is a side view, showing a longitudinal section of the tappet included in the high-pressure pump in FIG. 1.

FIG. 4 is a perspective view of the tappet in FIG. 2 and FIG. 3.

FIG. 5 is a diagram when the tappet in FIG. 4 is viewed from a direction indicated by Arrow V in FIG. 4.

FIG. 6 is a diagram when the tappet in FIG. 4 is viewed from a direction indicated by Arrow VI in FIG. 4.

FIG. 7 is a diagram when the tappet in FIG. 4 is viewed from a direction indicated by Arrow VII in FIG. 4.

FIG. 8 is a diagram when the tappet in FIG. 4 is viewed from a direction indicated by Arrow VIII in FIG. 4.

FIG. 9 is an enlarged view, showing part of the tappet indicated by a Roman figure IX in FIG. 2.

FIG. 10 is a diagram when part of a roller bearing, which is included in the tappet in FIG. 2, is viewed from a direction indicated by Arrow X in FIG. 9.

FIG. 11 is a sectional view, showing part of the roller bearing included in the tappet in FIG. 2, taken in lines XI-XI in FIG. 9.

FIG. 12 illustrates a pressing process for forming an intermediary workpiece, from which a case included in the tappet according to an embodiment of the present invention is to be made.

FIG. 13 is a schematic diagram of the intermediary workpiece for the case included in the tappet according to an embodiment of the present invention.

FIG. 14 is a schematic diagram of an intermediary workpiece for the case included in a tappet according to another embodiment of the present invention.

FIG. 15 is a side view, showing a longitudinal section depicting a state of contact between an intermediate bottom and a plunger in an embodiment of a case included in a tappet according to the present invention.

FIG. 16 is a side view, showing a longitudinal section depicting a state of contact between an intermediate bottom and a plunger in another embodiment of a case included in the tappet according to the present invention.

FIG. 17 is a front view, showing a longitudinal section of another embodiment of the tappet according to the present invention.

FIG. 18 is a side view, showing a longitudinal sectional side view of another embodiment of the tappet according to the present invention.

FIG. 19 is a schematic diagram of an intermediary workpiece for a case which is included in a conventional tappet.

FIG. 20 is a sectional view showing part of a high-pressure pump which includes a conventional tappet.

### DESCRIPTION OF EMBODIMENTS

Hereinafter, embodiments of the present invention will be described based on the attached drawings.

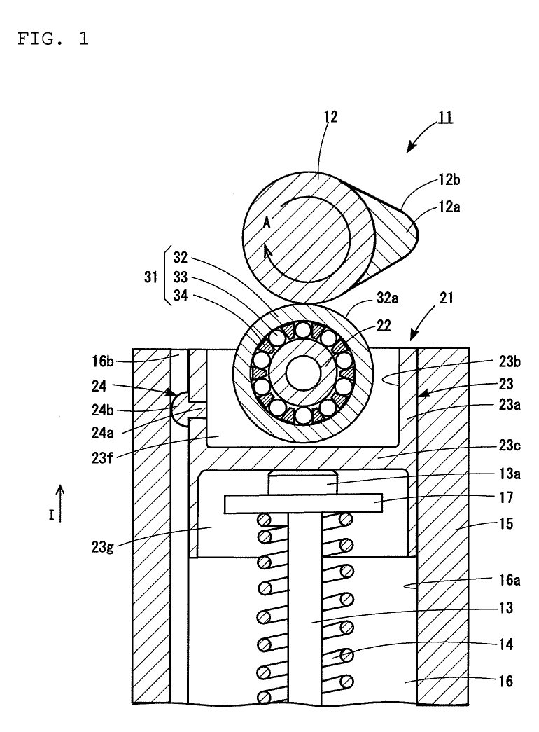

A high-pressure pump 11, which includes a tappet according to an embodiment of the present invention, is provided with a cam shaft 12, which is provided with a cam 12a on an outer diameter thereof and makes a rotating movement in Arrow A direction in FIG. 1; a tappet 21 which is in contact with the cam 12a, converts the rotating movement of the cam shaft 12 into a linear reciprocating movement of itself, transmits the converted movement to a pump plunger 13 (hereinafter, simply called “plunger”), and makes a linear reciprocating movement; the afore-mentioned plunger 13 which is a rod-like member that is in contact with the tappet 21 and makes a linear reciprocating movement; a high-pressure chamber (not illustrated) in which fuel is sent and pressurized to a high level in the course of the linear reciprocating movement of the plunger 13; a spring 14 which is in contact with the tappet 21 and is disposed around the plunger 13; and a housing 15 which houses the tappet 21, the plunger 13 and the spring 14.

The tappet 21, the plunger 3 and the spring 14 are disposed inside an open hole 16 formed in the housing 15. The tappet 21 is guided by an inner diameter surface 16a of the open hole 16 in an up-down direction as in FIG. 1, i.e., in a direction indicated by Arrow I or in the opposite direction thereto in FIG. 1.

The cam shaft 12 and the tappet 21 are disposed so that an outer diameter surface 12b of the cam 12a is in contact with an outer diameter surface 32a of an outer ring 32 of a roller bearing 31 which is included in the tappet 21. The plunger 13 is disposed so that its first end 13a is in contact with an intermediate bottom 23c provided in a case 23 which is included in the tappet 21. The spring 14 is disposed so that its end is in contact with a spring seat 17 which is provided below the intermediate bottom 23c.

The spring 14 stores its elastic force in a downward direction, i.e., the direction opposite to the direction indicated by Arrow I in FIG. 1. The tappet 21 is urged by the elastic force from the spring 14 via the plunger 13, in the upward direction, i.e., the direction indicated by Arrow I in FIG. 1.

Due to the rotating movement of the cam shaft 12, the urge from the spring 14, the guide by the inner diameter surface 16a of the open hole 16, etc., the tappet 21 and the plunger 13 make a linear reciprocating movement in the up-down direction, i.e., in the direction indicated by Arrow I in FIG. 1 or in the opposite direction. The term linear reciprocating movement used herein is a movement in direction indicated by Arrow I or in the opposite direction as in FIG. 1. The tappet 21 makes a linear reciprocating movement in the direction indicated by Arrow I in FIG. 1 and in the opposite direction while it may become slightly tilted. When the cam shaft 12 rotates at a high speed, the tappet 21 and the plunger 13 also move at a high speed in their linear reciprocating movement.

The high-pressure chamber is at another, unillustrated end of the plunger 13. Due to the linear reciprocating movement of the plunger 13, it is possible to bring the fuel which is supplied into the high-pressure chamber, to a high pressure.

Next, description will cover the tappet 21 according to the embodiment of the present invention. The tappet 21 includes a shaft 22; a roller bearing 31 which is disposed around an outer diameter of the shaft 22 and supported rotatably on the shaft 22; and a case 23 which houses the shaft 22 and the roller bearing 31.

The case 23 includes a cylindrical circumferential wall 23a and an intermediate bottom 23c which is provided at an intermediate position of an inner diameter surface 23b of the circumferential wall 23a, partitioning a space extending in the up-down direction. The case 23 is in contact with the plunger 13 on an intermediate bottom 23c. The circumferential wall 23a and the intermediate bottom 23c have predetermined thicknesses.

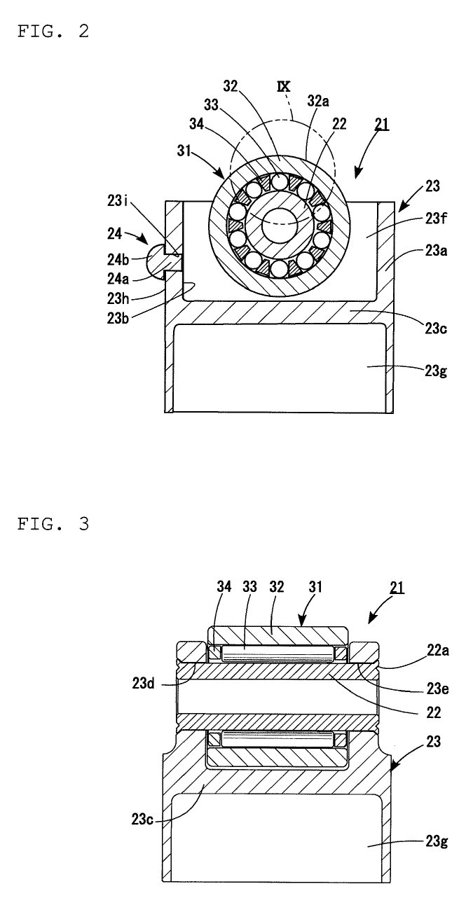

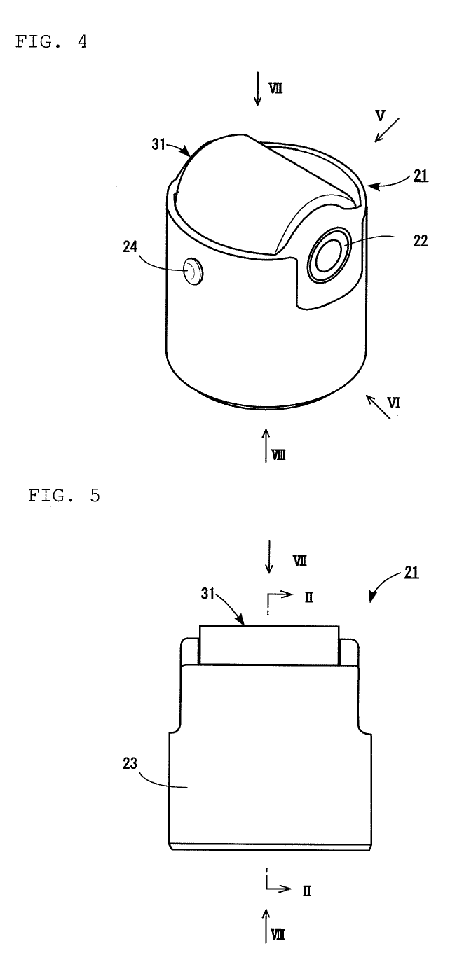

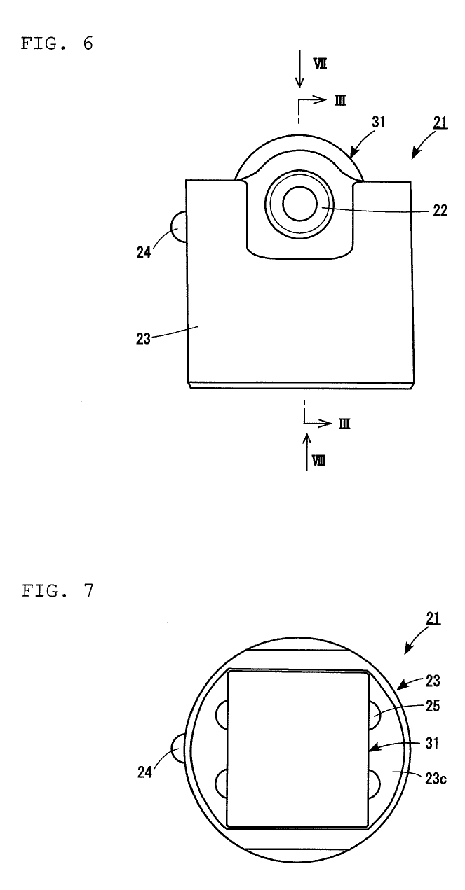

As shown in FIG. 3, a pair of support holes 23d, 23e is provided to support the shaft 22 near an end of the circumferential wall 23a. The shaft 22 is disposed by inserting the shaft 22 through these support holes 23d, 23e. The roller bearing 31 is disposed around the outer diameter of the shaft 22. As described, the case 23 houses the shaft 22 and the roller bearing 31 in a space 23f which begins from the intermediate bottom 23c to an end of the circumferential wall 23a.

The shaft 22 is cylindrical, and is fixed to the support holes 23d, 23e by swaging outer circumferential edges at each end surface of the shaft 22. The swage is indicated by a reference symbol 22a. By using a hollow shaft 22, the arrangement helps reducing the weight as compared to a case where the shaft is provided by a solid member.

A space 23g, which begins from the intermediate bottom 23c toward another end of the circumferential wall 23a, is where part of the plunger 13 is housed. Specifically, the first end portion 13a of the plunger 13 is disposed to make contact with a radially central portion of the intermediate bottom 23c, whereby the end portion 13a of the plunger 13 is housed here. The space 23g also houses an end portion of the spring 14.

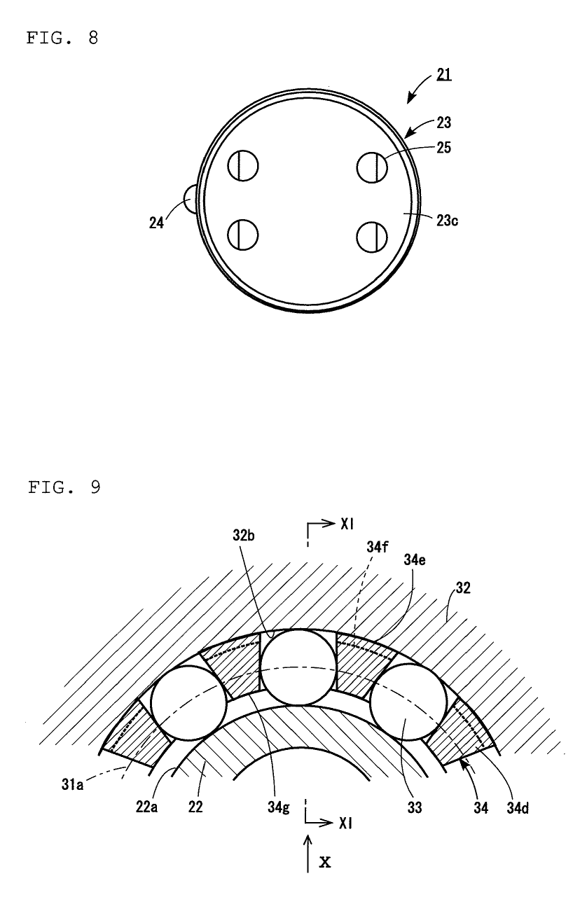

The intermediate bottom 23c is formed with four oil holes 25 penetrating the intermediate bottom in its thickness direction (see FIG. 7 and FIG. 8). The four oil holes 25 are positioned to avoid the area of contact between the first end portion 13a of the plunger 13 and the intermediate bottom 23c. Using these oil holes 25, it is possible to supply a lubricant to the tappet 21 through the space 23f and the space 23g.

As shown in FIG. 2, a through-hole 23i penetrates the case 23 from an outer diameter surface 23h to an inner diameter surface 23b of the circumferential wall 23a, serving as a recess. The through-hole 23i is fitted with a whirl-stop pin 24, part of which protrudes from the outer diameter surface 23h. The whirl-stop pin 24 positions the tappet 21 inside the open hole 16. Specifically, the tappet 21 includes a whirl-stop pin 24 for positioning the case 23.

The whirl-stop pin 24 has a leg 24a which is fitted into the through-hole 23i, and a semispherical head 24b which protrudes from the outer diameter surface 23h. The whirl-stop pin 24 has its leg 24a press-fitted into the through-hole 23i, thereby fixed to the through-hole 23i and therefore does not drop therefrom.

The housing 15 has an open hole 16 surrounded by an inner diameter surface 16a, which is formed with a groove 16b recessing from the inner diameter surface 16a and extending in a direction indicated by Arrow I in FIG. 1. When the tappet 21 is placed into the open hole 16, the head 24b of the whirl-stop pin 24 is fitted into the groove 16b. By doing so, the case 23 in the open hole 16 and the tappet 21 are positioned circumferentially. The arrangement prevents the tappet 21 from rotating in the circumferential direction in the open hole 16.

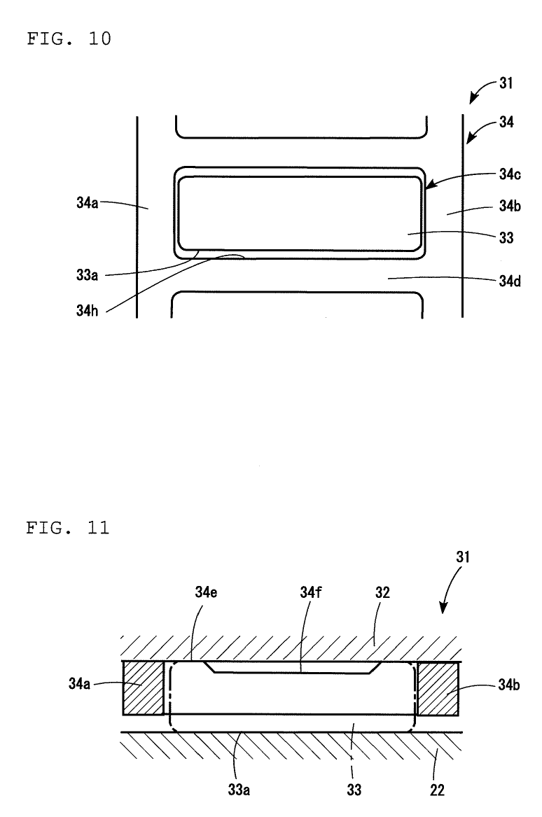

Next, description will cover the roller bearing 31 which is included in the tappet 21. FIG. 9 is an enlarged view of a portion circled by an alternate long and two short dashes line indicated by a Roman number IX in FIG. 2. The alternate long and short dash line in FIG. 9 show a roller pitch circle 31a. FIG. 10 is a diagram when part of the roller bearing 31 is viewed from a direction indicated by Arrow X in FIG. 9. FIG. 11 is a sectional view of a part of the roller bearing 31, taken in lines XI-XI in FIG. 9. The roller bearing 31 includes an outer ring 32, a plurality of rollers 33 disposed between the outer ring 32 and the shaft 22, and a retainer 34 which holds a plurality of the rollers 33.

The retainer 34 includes a pair of annular portions 34a, 34b, and a plurality of post portions 34d which connect the annular portion 34a, 34b while providing pockets 34c for holding the rollers 33. The post portions 34d extend axially, i.e., in a direction to penetrate the sectional view in FIG. 9 straightly from the paper's top surface toward the bottom surface thereof.

The retainer 34 is disposed between the outer ring 32 and the shaft 22, like the rollers 33. Each of the rollers 33 is housed in and held by one of the pockets 34c formed in the retainer 34. The retainer 34 is an outer-diameter-guide type, in other words, the outer ring 32 disposed around the retainer 34 has an inner diameter surface 32b, which makes radial contact with an outer diameter surface 34e of the retainer 34. The retainer 34 is provided with an oil groove 34f, recessing inward from the outer diameter surface 34e. The oil groove 34f is formed along a center of the post portions 34d, and extends in a circumferential direction.

As the cam shaft 12 makes its rotating movement, the outer ring 32 and the rollers 33 also rotate as constituent members of the roller bearing 31. When the cam shaft 12 rotates at a high speed, the rollers 33 also rotate at a high speed. Under the present arrangement where the tappet 21 includes the roller bearing 31 as a constituent member, the retainer 34 stabilizes the position of the rollers 33 in the roller bearing 31 during high-speed rotation. Stable positioning means reduced skewing of the rollers 33. In other words, the arrangement reduces skewed travel of the roller bearing 31. The arrangement thus reduces a risk of poor lubrication of the roller bearing 31 and wear of the roller bearing 31 during high-speed rotation. In other words, the pump tappet such as described above can be manufactured at a low cost, and has a long life.

Also, the high-pressure pump 11 can be manufactured at a low cost and can pressurize the fuel more stably in a short time since it includes the tappet 21 which can be manufactured at a low cost and reduce a risk of poor lubrication of the roller bearing 31 and wearing of the roller bearing 31 during high-speed rotation.

According to the present arrangement, the retainer 34 is an outer-diameter guide type and the retainer 34 has its outer diameter surface 34e formed with an inward recessing oil grooves 34f. Therefore, the arrangement brings the retainer 34 and the outer ring 32 into contact thereby achieving stable radial positioning of the retainer 34. Also, the arrangement improves movement of the lubricant between the inner diameter surface 34g of the retainer 34 and the outer diameter surface 22a of the shaft 22, improves lubrication between the outer diameter surface 34e of the retainer 34 and the inner diameter surface 32b of the outer ring 32, and thereby reduces wear of the retainer 34 and the outer ring 32. Therefore, the arrangement increases life of the retainer 34, the rollers 33, the outer ring 32 and the shaft 22. It should be noted here that the oil groove may be axially inclined or curved. Also, a plurality of oil grooves may be provided.

It should be noted here that the retainer 34 may be of an inner-diameter guide type, with an oil groove provided in the inner diameter surface 34g of the retainer 34. In such an arrangement, the retainer 34 and the shaft 22 contact with each other, achieving stable radial positioning of the retainer 34. Also, such an arrangement improves movement of the lubricant between the outer diameter surface 34e of the retainer 34 and the inner diameter surface 32b of the outer ring 32, improves lubrication between the inner diameter surface 34g of the retainer 34 and the outer diameter surface 22a of the shaft 22, and thereby reduces wearing of the retainer 34 and the shaft 22. Therefore, the arrangement increases life of the retainer 34, the rollers 33, the outer ring 32 and the shaft 22.

The retainer 34 which is included in the roller bearing 31 may be made of a resin. Such an arrangement reduces the weight of the retainer 34 itself, and therefore helps reducing the overall weight of the tappet 21. The arrangement therefore reduces a force required in the linear reciprocating movement, i.e., the force required to move the tappet 21 in the up-down direction. Another advantage of making the retainer 34 of a resin is that the arrangement allows use of an injection molding technique for example, which allows high-volume production and low cost manufacturing achieved thereby, easily. Examples of the resin usable for the retainer 34 include nylon 66, nylon 46, polyphenylene sulfide (PPS), and polyetheretherketone (PEEK). Carbon fibers, glass fibers, carbon black and others may be added to the resin as necessary.

It should be noted here that FIG. 10 shows exaggeratingly large gap between a roller surface 33a of the roller 33 in the pocket 34c and side wall surface 34h of the post portions 34d, for the sake of easier understanding.

It should also be noted here that the rollers and the shaft which constitute the tappet described thus far are made of a steel material such as SUJ2 and SCM420 (both nomenclatures are from Japanese Industrial Standards), using various machining processes such as forging and cutting.

In the embodiment described above, the whirl-stop pin is fitted into a recess which is provided by a through-hole penetrating the case from its inner diameter surface through the outer diameter surface. However, the present invention is not limited to this. In other words, the recess may not penetrate the case from its inner diameter surface to outer diameter surface. Further, the recess may be formed to follow the outer diameter surface of the whirl-stop pin. In other words, the recess may have a recessed seat to be mated by the outer diameter surface of the case. Such an arrangement provides more complete fitting between the whirl-stop pin and the recess, thereby ensuring improved fitting between the outer diameter surface of the whirl-stop pin and the recess in the case.

In the previous embodiments, the retainer includes a pair of annular portions and a plurality of post portions. However, the present invention is not limited to this. For example, the retainer may not be a one-piece type, but instead be a multi-piece type which is constituted by a plurality of pieces each to be placed between rollers.

Also in the previous embodiments, the post portions are provided by axially extending straight portions. However, the present invention is not limited to this. For example, the post portions may be radially bent, i.e., that the retainer may be of a type called V-shaped retainer or M-shaped retainer for example. Further, the post portions may have their side wall surfaces provided with roller stoppers for preventing the rollers from falling radially.

In the previous embodiments, the roller bearing has a retainer which holds a plurality of rollers. However, the present invention is not limited to this. For example, the present invention is also applicable to configurations where roller bearings do not include retainers, i.e., configurations which include full roller bearings.

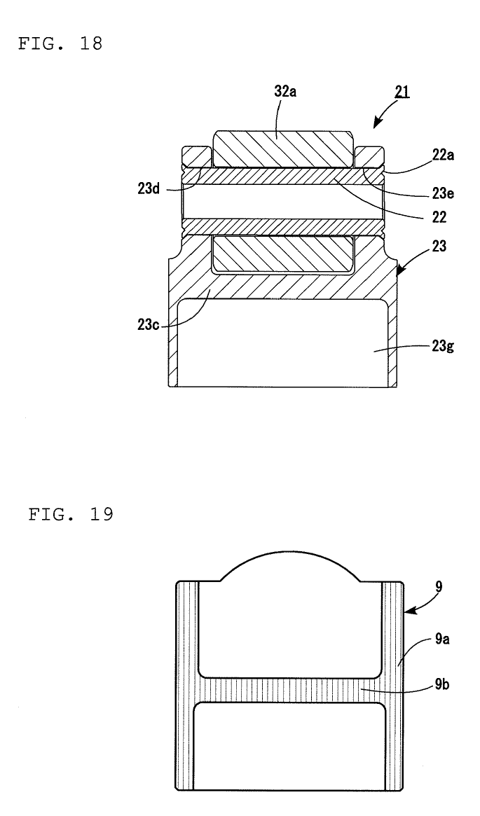

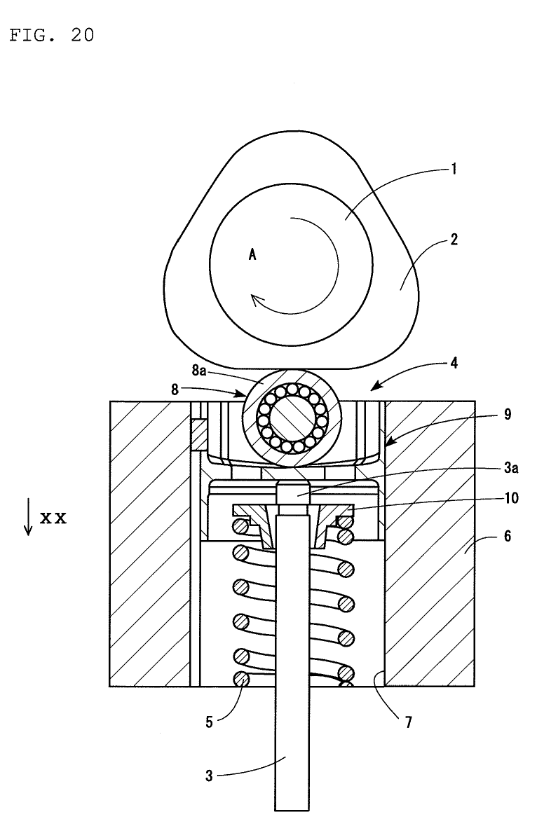

In the embodiments described so far, the tappet 21 has a roller bearing 31 around the outer diameter surface of a shaft 22. Now, an embodiment shown in FIG. 17 and FIG. 18 does not include a rolling element, and an example of the tappet 21 that has an outer ring 32a rotatably around the outer diameter surface of the shaft 22. Hereinafter, elements common to those in the previous embodiments are indicated by the same reference symbols and their descriptions will not be repeated.

Next, the case 23 which is a constituent member of the tappet 21 according to the present invention will be described. As described earlier, the case 23 includes a cylindrical circumferential wall 23a and an intermediate bottom 23c which is provided at an intermediate position of an inner diameter surface 23b of the circumferential wall 23a, partitioning the space extending in the up-down direction.

As understood from FIG. 19, the case 23 is conventionally made by hollowing out a solid round steel bar by means of cutting operations, and as represented by fine lines in the schematic diagram in FIG. 19, the intermediate bottom is formed by removing the material and leaving a short bundle of parallel fiber flow in the thickness direction. This has been a cause of a problem that the intermediate bottom is susceptible to fracture along the fiber flow direction when a large load is applied from the plunger in the direction of the fiber flow.

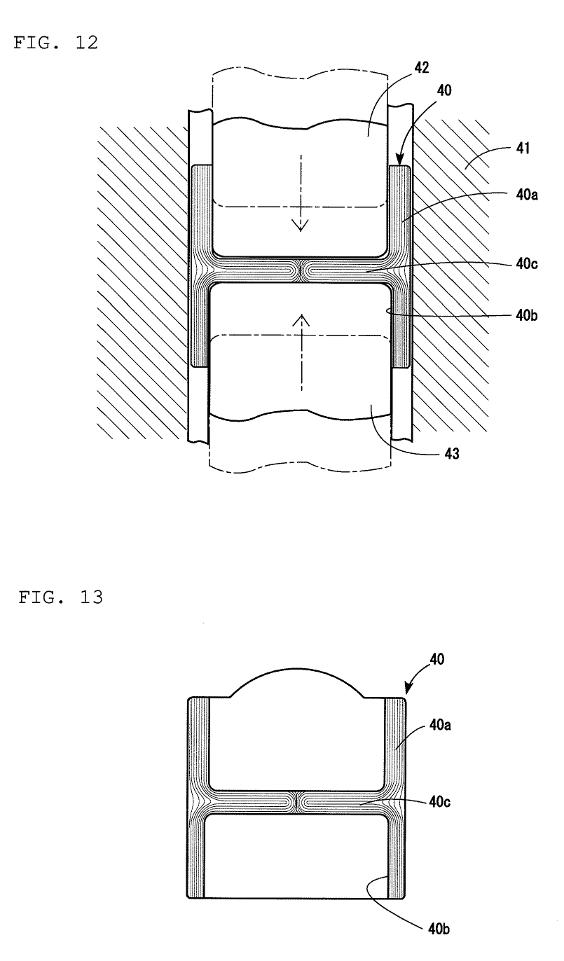

In order to solve such a problem as this, the present invention makes use of an arrangement as shown in FIG. 12, i.e., a cold forging process is performed to the round steel material, to form an intermediary workpiece 40 from which the case 23 is made. The intermediary workpiece 40 includes a circumferential wall 40a which will be formed into the cylindrical circumferential wall 23a of the case 23; and an intermediate bottom 40c which is provided at an intermediate position of an inner diameter surface 40b of the circumferential wall 40a to partition the space extending in the up-down direction provided by the circumferential wall 40a. The intermediate bottom 40c will be formed into the intermediate bottom 23c of the case 23.

As shown in FIG. 12, the intermediary workpiece 40 is formed by pressing a center portion of a round steel material with an upper punch 42 and a lower punch 43 in a dice 41, thereby pushing the metal in the central region radially outward, forcing the metal to flow axially in the up-down direction to form the intermediate bottom 40c and the cylindrical circumferential wall 40a.

As shown in FIG. 13, the intermediary workpiece 40 for the case 23 which is formed by the above-described process has a continuous fiber flow from the intermediate bottom 40c to the circumferential wall 40a.

A case 23 which is formed from the intermediary workpiece 40 has an uncut, continuous fiber flow in its intermediate bottom 23c. Therefore, the intermediate bottom 23c has a high load bearing capability even if its thickness is reduced. Therefore, it is possible to reduce the overall weight of the case 23. The reduced weight reduces inertia of the tappet 21 when it makes the reciprocating movement, reducing a risk of jumping and thereby allowing the pump to work efficiently.

When the case 23 is formed from the intermediary workpiece 40, the cold forging process may be performed in such a way that the continuous fiber flow in the intermediate bottom 23c will become 90 degrees with respect to the direction of load from the plunger 13. This further improves the load bearing capability to the load from the plunger 13.

In the cold forging process as described above, the intermediate bottom 23c of the case 23 is formed by pressing a central region of the round steel material from both surfaces. This increases the fiber flow density in the intermediate bottom 23c over the other regions of the case 23, resulting in further improved load bearing capability of the intermediate bottom 23c.

Further, the case 23 which is formed by the cold forging process as described also has higher fiber flow density at corner portion made by the intermediate bottom 23c and the cylindrical circumferential wall 23b than other portions. This further improves the load bearing capability of the intermediate bottom 23c.

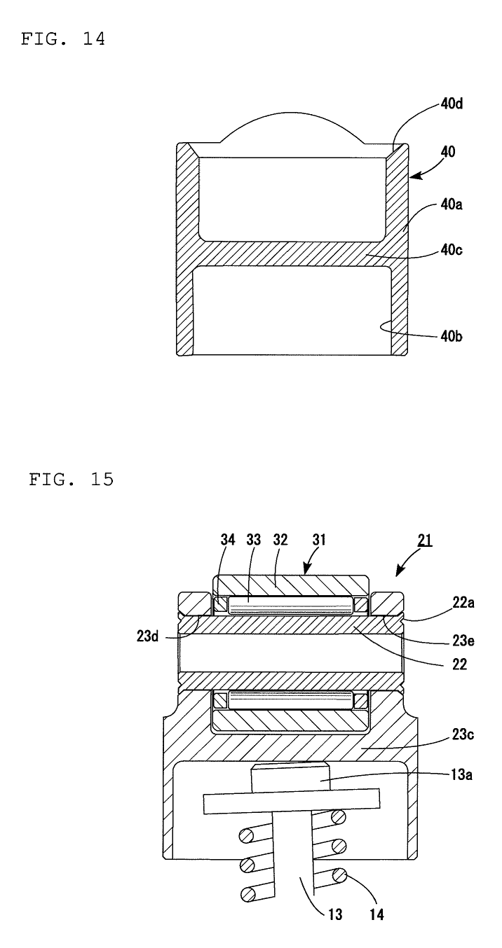

Further, when forming the intermediary workpiece 40 of the case 23 by cold forging process, there may be an arrangement where the cylindrical circumferential wall 40a of the intermediary workpiece 40 has its upper edge portion formed into an inward down slope 40d as shown in FIG. 14. This provides an intermediary workpiece 40 of the case 23 which has an even lighter weight, without changing the height of the case as measured in Direction I at the outer diameter as in FIG. 1, or without reducing the surface area of contact between the outer diameter surface of the case and the inner diameter surface 16a of the open hole 16.

Preferably, when forming the case 23 from the intermediary workpiece 40, an ironing process should be performed to the inner diameter surface 23b of the space 23f in the case 23 where the shaft 22 and the roller bearing 31 are housed, in order to improve surface coarseness for the contact with the width-defining surfaces of the outer ring 32 of the roller bearing 31. Improving the coarseness in the contact surface reduces heat and wear caused by the contact with the width-defining surfaces of the outer ring.

Also, when machining the intermediary workpiece 40 for formation of the case 23, it is preferable that the machining should be performed in such a way that the cylindrical circumferential wall 40a will have a center of gravity off a shaft fixing region of the roller bearing 31. This allows the intermediate work piece 40 to be subjected to centerless grinding operation for its outer surface grinding without a risk that the case 23 will tilt toward the shaft fixing portion. The arrangement stabilizes the attitude of the case 23 during the centerless grinding operation to be performed to the outer surface of the intermediate work piece 40.

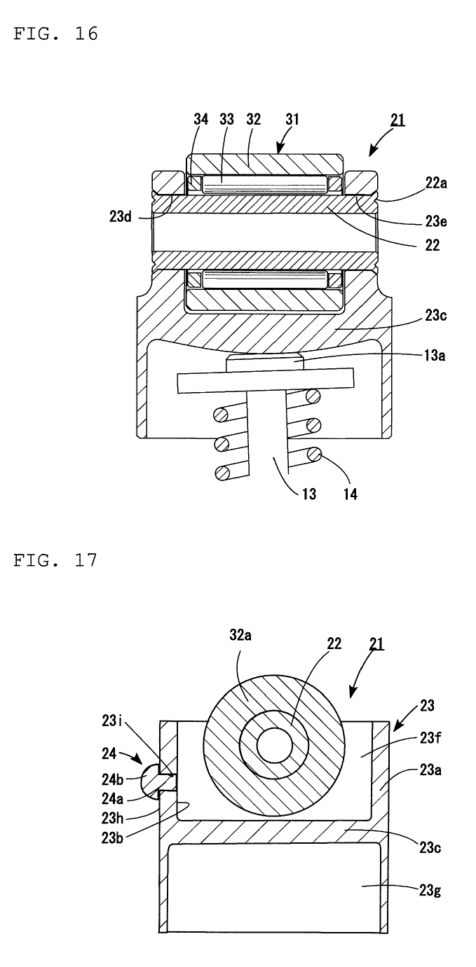

Next, FIG. 15 shows an embodiment, where the case 23 has a flat intermediate bottom 23c as a surface for contact with the first end portion 13a of the plunger 13. The intermediate bottom 23c of the case 23 which is made flat as described has a disadvantage as understood from FIG. 15 that if the plunger 13 becomes skew due to installation errors, tolerance gap, etc. in its contact with the intermediate bottom 23c of the case 23, the first end portion 13a of the plunger 13 makes angled contact with the intermediate bottom 23c of the case 23, making the intermediate bottom 23c of the case 23 susceptible to accelerated wear. As a solution to this problem, FIG. 16 shows an embodiment, where the case 23 has an intermediate bottom 23c which has a convex surface to make contact with the first end portion 13a of the plunger 13. The convex intermediate bottom 23c of the case 23 as described has an advantage that even if the plunger 13 becomes skew, the plunger 13 does not make angled contact with the intermediate bottom 23c and therefore reduces wear of the intermediate bottom 23c due to the contact with the first end portion 13a of the plunger 13.

Thus far, embodiments of the present invention have been described with reference to the drawings. However, the present invention is not limited to these illustrated embodiments. Any of these embodiments illustrated thus far may be modified or changed in many ways within the scope or within the equivalence of the present invention.

### INDUSTRIAL APPLICABILITY

The tappet according to the present invention may be used as an automotive part included in a high-pressure pump for supplying fuel to an engine of the automobile for example.

### REFERENCE SIGNS LIST

11 high-pressure pump
12 cam shaft
12a cam
13 plunger
13a first end portion
21 tappet
22 shaft
23 case
23a circumferential wall
23c intermediate bottom
31 roller bearing
32, 32a outer ring
33 rollers
40 intermediary workpiece
40a circumferential wall
40c intermediate bottom

1. A pump tappet for converting a rotating movement of a cam-driven cam shaft into a linear reciprocating movement to be transmitted to a pump plunger while making a linear reciprocating movement together with the pump plunger, wherein
the tappet comprises a shaft; an outer ring disposed rotatably around an outer diameter surface of the shaft; and a case which houses the shaft and the outer ring,
the case including a cylindrical circumferential wall and an intermediate bottom provided at an intermediate position of the inner diameter surface of the circumferential wall to partition a space extending in an up-down direction,
the case being formed by a cold forging process of pressing a central region of a round steel material from both surfaces thereby pushing a portion of the material at the central region radially outward, forcing the material to flow axially in the up-down direction, thereby leaving a continuous fiber flow in the intermediate bottom region.

2. The pump tappet according to claim 1, wherein the outer ring is provided around the shaft via a rolling element.

3. The pump tappet according to claim 1, wherein the continuous fiber flow in the intermediate bottom is 90 degrees with respect to a direction in which a load from the plunger is applied.

4. The pump tappet according to claim 1, wherein the intermediate bottom has a higher fiber flow density than other regions of the case.

5. The pump tappet according to claim 1, wherein a connecting region between the intermediate bottom and the cylindrical circumferential wall has a higher fiber flow density than other regions of the case.

6. The pump tappet according to claim 1, wherein the cylindrical circumferential wall has an edge portion formed as an inward down slope.

7. The pump tappet according to claim 1, wherein the case's cylindrical circumferential wall has an ironed inner diameter surface for contact by the outer ring's width-defining surfaces.

8. The pump tappet according to claim 1, wherein the case's center of gravity is off a shaft fixing region.

9. The pump tappet according to claim 1, wherein the intermediate bottom of the case has a convex surface for contact with the pump plunger.

10. A high pressure fuel pump comprising the pump tappet according to claim 1.

11. An automobile or a motorcycle comprising the high pressure fuel pump according to claim 10.
